(19) United States
(12) Patent Application Publication
(10) Pub. No.: US 2006/0029729 A1
(43) Pub. Date: Feb. 9, 2006

(54) Application of spray paint on disk media for protection of titling and/or graphics on labels or markings

(76) Inventor: Jonathan Douglas Myers, Springville, UT (US)

Correspondence Address: Jonathan Douglas Myers, 1566 West 970 South, Springville, UT, 84663, US

(21) Appl. No.: 10/892,427

(22) Filed: Jul. 16, 2004

(51) Int. Cl. B05D 5/06

(52) U.S. Cl. 427/162

(57) ABSTRACT

Currently there is one product that is designed to protect the words, pictures, graphics, labels or other markings on disks. That product is a laminator that uses thermal energy to apply a plastic to the surface of the disk. My invention is different in that it uses paint, and not a thermal transfer to protect the words, pictures, graphics, labels or other markings on disks.

### CROSS REFERENCE TO RELATED APPLICATIONS

No related applications are cross-referenced.

### Copyright Statement

No copyrights apply or are relevant to this invention or this patent application

### FEDERAL RESEARCH STATEMENT

No Federal money source or any other form of Federal support financial or otherwise was used in conjuntion with this invention or this patent application. All rights to this invention and related patent application pertain solely to the applicant.

### BACKGROUND OF INVENTION

This invention closely relates to U.S. patent Classification Definitions 427, “Coating Processes”. Compact disk media including all forms of Compact Disks (CD's), Digital Video Disks (DVD's) and other forms of disk media and storage can be labelled. One common way to label such disks is by using ink jet printers to print either directly onto the disk, or onto a sticker or paper that is applied to the disk. Using ink jet printers to label disks has many problems. The problem I addressed with my invention is that such labels are not protected. The ink on these types of labels smears, runs, fades, and otherwise changes unless protected.

### SUMMARY OF INVENTION

The problem of a label or mark changing after having been printed directly onto a disk, or onto any form of paper, including labels which is then adhered to any form of disk is what I address in this invention and patent application. My invention is to spray paint onto the labelled or marked side of a disk that has been labelled or otherwise marked with the use of an ink jet or laser jet type printer either directly or indirectly.

### DETAILED DESCRIPTION

The problem of a label or mark changing after having been printed directly onto a disk, or onto any form of paper, including lables which is then adhered to any form of disk is what I address in this invention and patent application. My invention is to spray paint onto the labelled or marked side of a disk that has been labelled or otherwise marked with the use of an ink jet or laser jet type printer either directly or indirectly.

The process is as follows: Hold a can of spray paint six to ten inches directly above a disk that has been labelled or marked as described above. Dispense the paint from the spray can for one-half of one second while moving the spray can quickly from one side of the disk to the other such that the paint emmitted from the spray can is evenly applied to the exposed area of the disk.

Program Listing Deposit

1. What I claim as my invention is: the process of applying paint to words, pictures, graphics, labels or other markings on disks (such as compact disks, digital video disks, or other disks of similar proportions) which application protects the words, pictures, graphics, labels or other markings from sunlight, water, heat, grease and other materials that can in some way alter their appearance, design or integrity.
